(19) United States
(12) Patent Application Publication
(10) Pub. No.: US 2016/0299063 A1
(43) Pub. Date: Oct. 13, 2016

(54) ATR ELEMENT, IMMERSION PROBE, AND SPECTROPHOTOMETER

(71) Applicant: DIC CORPORATION, Itabashi-ku, Tokyo (JP)

(72) Inventor: Shouei Ebisawa, Sakura-shi (JP)

(21) Appl. No.: 15/028,553

(22) PCT Filed: Sep. 30, 2014
(86) PCT No.: PCT/JP2014/004989

§ 371 Date: Apr. 11, 2016

(30) Foreign Application Priority Data
Oct. 11, 2013 (JP) 2013-213415

(51) Int. Cl. G01N 21/3577; G01N 21/359; G01N 21/85; G01N 21/552

(52) U.S. Cl. CPC G01N 21/3577; G01N 21/552; G01N 21/359; G01N 21/8507; G01N 2201/061

(57) ABSTRACT

Provided is an ATR element which uses measuring light in a near-infrared region and can precisely determine the state of a substance even if the substance has a low absorption coefficient for the measuring light. An ATR element 10 including: an element main body 11 having a reflective surface 13 continuous in a circumferential direction; an entrance surface 19 through which measuring light DL enters the element main body 11; and an exit surface 21 through which the measuring light DL entering through the entrance surface 19 and reflected off the reflective surface 13 of the element main body 11 exits to the outside, wherein the measuring light DL having entered through the entrance surface 19 follows a spiral passage route while repeatedly reflecting off the reflective surface 13 before exiting through the exit surface 21 toward the outside.

### TECHNICAL FIELD

The present invention relates to an immersion probe suitable for measuring changes in concentration of a reactive group of a synthetic resin, for example, and more particularly to an ATR element.

### BACKGROUND ART

Grasping the progress of reactions in the process of producing a synthetic resin, such as polyurethane or polyester, requires precise in-line measurement of changes in concentration of a reactive group (e.g., —NCO, —OH, —COOH) contained in a reaction liquid being measured.

An immersion probe is conventionally known which includes a detection element to be immersed in a reaction liquid, an irradiation optical fiber through which the detection element is irradiated with measuring light, and a light-receiving optical fiber which receives the measuring light having passed through the object being measured (e.g., Patent Literature 1). In this immersion probe, the detection element is provided with a cavity to be filled with an object being measured, and measuring light penetrating the object being measured filling the cavity is received by the light-receiving optical fiber. Since a part of the wavelength components of the measuring light is absorbed while the measuring light is penetrating the object being measured in the cavity, the concentration of a reactive group can be measured through the analysis of the measuring light received by the light-receiving optical fiber. However, as the reaction liquid is agitated in a chemical reaction tank, the cavity may be filled with a reaction liquid having air bubbles trapped therein by agitation, and these air bubbles represent noise in the detection of the concentration of a reactive group, making it difficult to measure the precise concentration.

Here, the attenuated total reflection (ATR) method is known as one of techniques for analyzing and measuring substances. An immersion probe based on this ATR method is also known (e.g., Patent Literature 2).

The analysis by the ATR method can be briefly summarized as follows. An object being measured is placed in close contact with an ATR element (typically a crystal) having a high refractive index, and the entry angle of measuring light is set to be larger than a critical angle so that total reflection occurs between the object being measured and the ATR substance. When total reflection occurs, light is reflected at the interface between the object being measured and the ATR element after penetrating a little into the object being measured. This reflected light is called evanescent light. In a region of the object being measured where the measuring light is absorbed, the energy of the reflected light in a wavelength specific to the object being measured decreases according to the absorption intensity. The substance can be analyzed and measured by measuring the spectrum of this reflected light.

### CITATION LIST

### Patent Literature

Patent Literature 1: JP 2009-250825 A
Patent Literature 2: JP 2004-85433 A

### SUMMARY OF INVENTION

### Technical Problem

If the above-mentioned measurement of the concentration of a reactive group of a synthetic resin is assumed, there may be a considerable distance from a reaction tank containing a reaction liquid, in which the immersion probe is immersed, to a spectrophotometer to which the measurement result is transmitted. As connection between the two is formed by an optical fiber, the wavelength of measuring light radiated to the immersion probe is a problem.

When the precise measurement of the concentration of a reactive group is taken into account, it is recommended to use measuring light in a region of wavelengths of 2500 nm or longer, for example, but light in this wavelength region suffers significant attenuation through an optical fiber, which makes it difficult to put such light to practical use. On the other hand, light in a near-infrared region having a wavelength of 1000 to 2000 nm attenuates little through an optical fiber, and therefore can be guided through an optical fiber without problem. However, since reactive groups have an extremely low absorption coefficient for light in a near-infrared region, it is difficult to precisely measure the concentration of the reactive groups.

Having been devised in view of the above technical problems, the present invention aims to provide an ATR element which uses measuring light in a near-infrared region which is easy to guide through an optical fiber, and which can precisely determine the state of a substance even if the substance has a low absorption coefficient for the measuring light.

### Solution to Problem

When the object being measured is a substance with a low absorption coefficient, it is desirable to increase the total amount of light absorbed by the object being measured during the period between the entry and exit of measuring light into/from the probe by increasing the number of reflections as much as possible.

Known probes based on the ATR method include, not only a single-reflection type in which the number of reflections is one, but also a multiple-reflection type in which the number of reflections is plural. However, the number of reflections in the ATR element of a conventionally known trapezoidal multiple reflection-type probe is about 20, which is still not enough for the objects being measured for which the present invention is intended.

Therefore, the present inventors have considered an ATR element which can realize an immersion probe capable of achieving a drastically larger number of reflections than the conventional probes. As a result, we found that a number of reflections exceeding that of the conventional multiple reflections could be achieved by using an ATR element which has the side surface continuous in the circumferential direction as a reflective surface and causing measuring light to continuously reflect off the reflective surface to thereby effectively utilize the evanescent light.

Based on this finding, the ATR element of the present invention includes: an element main body formed by an axisymmetric solid and having a reflective surface continuous in a circumferential direction; an entrance part through which measuring light enters the element main body; and an exit part through which the measuring light entering through the entrance part and reflected off the reflective surface of the element main body exits to the outside, wherein the measuring light having entered through the entrance part follows a spiral passage route while repeatedly reflecting off the reflective surface before exiting through the exit part toward the outside.

In the ATR element of the present invention, in order for the measuring light to follow the spiral passage route while repeatedly reflecting off the reflective surface, it is preferable that, in a reference cross-section x perpendicular to the axis of symmetry of the element main body, the entrance part is located at a distance of 80% or more but less than 100% of the distance from the axis of symmetry to the outer circumference of the reference cross-section x (Condition A), and that the entrance part and the reference cross-section x form an angle of 45 degrees or less (Condition B).

Condition A is required primarily for gaining the number of reflections of the measuring light.

Condition B is required primarily for the measuring light to follow the spiral passage route.

In the ATR element of the present invention, it is preferable that the element main body has a cylindrical form or a tubular form.

The cylindrical element main body has an arc-shaped reflective surface, and this reflective surface has a constant distance from the axis of symmetry.

If the ATR element has a tubular shape, not only the outer circumferential surface but also the inner circumferential surface can serve as the reflective surface, which is effective in increasing the number of reflections of the measuring light.

In the ATR element of the present invention, it is preferable that the element main body has a first end face facing in the axial direction and a second end face facing the first end face; that the entrance part is provided by forming a recess in the first end face; and that the exit part is provided by forming a recess in the second end face.

This is because it is easier to form the entrance part and the exit part in recesses than to form them by protruding the end faces of the element main body.

In the ATR element of the present invention, it is preferable, in terms of increasing the number of reflections, that the entrance part is formed so as to be continuous with the outer circumference of the first end face, and that the exit part is formed so as to be continuous with the outer circumference of the second end face.

The present invention provides an immersion probe using the ATR element of the present invention having been described above.

That is, this immersion probe includes: an ATR element having an element main body formed by an axisymmetric solid and having a reflective surface continuous in the circumferential direction, an entrance part through which measuring light enters the element main body, and an exit part through which the measuring light entering through the entrance part and reflected off the reflective surface of the element main body exits to the outside; first light-guiding means which guides the measuring light emitted from a light source to the entrance part; and second light-guiding means which guides the measuring light exiting through the exit part to a predetermined position, wherein the ATR element is the ATR element of the present invention having been described above.

The immersion probe of the present invention can gain the number of reflections of measuring light in the reflective surface of the ATR element to be used, and can also effectively utilize evanescent light, which contributes to precise measurement of the state of a substance even if the substance has a low absorption coefficient for the measuring light.

The present invention provides a spectrophotometer using the immersion probe of the present invention having been described above.

That is, this spectrophotometer includes: a light source which emits measuring light; and a photometer main body which disperses and detects the measuring light having passed through the immersion probe, wherein the immersion probe is the immersion probe of the present invention having been described above.

The spectrophotometer of the present invention can gain the number of reflections of measuring light in the reflective surface of the ATR element of the immersion probe, which contributes to precise measurement of the state of a substance even if the substance has a low absorption coefficient for the measuring light.

### Advantageous Effects of Invention

According to the present invention, a larger number of reflections than is conventionally possible is realized by using the ATR element which has the side surface continuous in the circumferential direction as the reflective surface and causing measuring light to continuously reflect off the reflective surface. Thus, it is possible to use measuring light in a near-infrared region and precisely measure the state of a substance even if the substance has a low absorption coefficient for the measuring light.

Moreover, according to the present invention, it is possible to favorably manufacture a desired final product by monitoring the process of synthetic reactions of the product, as long as the product, whether it is organic or inorganic, undergoes synthetic reactions in the manufacturing process, such as synthetic resin products, liquid crystal products, or pigment products, and thus a reaction product manufacturing method can be provided. In addition, the present invention can be used in a wide range of applications including, not only manufacturing-related process management in the fields of chemical goods, medical goods, industrial powder goods, foods, etc., but also, by industry, chemistry; various resins and plastics represented by polyurethane, polyester, epoxy, and reactive hot melt; test, analysis, and measurement; medical goods and biology; education/research institutions, etc.

### BRIEF DESCRIPTION OF DRAWINGS

FIGS. 1A to 1D are three-side views showing a cylindrical ATR element in an embodiment, in which FIG. 1A is a plan view, FIG. 1B is a side view, FIG. 1C is a bottom view, and FIG. 1D shows a modified example corresponding to FIG. 1B.

FIGS. 2A to 2C are views illustrating Condition A of the embodiment.

FIGS. 3A to 3C are views illustrating Condition B of the embodiment.

FIGS. 4A to 4C are views schematically showing a passage route of measuring light in the ATR element of FIGS. 1A, 1B, and 1C, in which FIGS. 4A, 4B, and 4C correspond to FIGS. 1A, 1B, and 1C, respectively.

FIGS. 5A to 5C are three-side views showing a prismatic ATR element in the embodiment, in which FIG. 5A is a plan view, FIG. 5B is a side view, and FIG. 5C is a bottom view.

FIGS. 6A to 6C are three-side views showing a truncated conical ATR element in the embodiment, in which FIG. 6A is a plan view, FIG. 6B is a side view, and FIG. 6C is a bottom view.

FIGS. 7A to 7C are three-side views showing a tubular ATR element in the embodiment, in which FIG. 7A is a plan view, FIG. 7B is a side view, and FIG. 7C is a bottom view.

FIG. 8 is a view showing the configuration of a spectrophotometer using the ATR element of the embodiment.

FIG. 9 is a view showing the configuration of an immersion probe used for the spectrophotometer of FIG. 8.

FIG. 10 is a view showing an overview of an experiment performed to confirm the effects of the embodiment.

FIGS. 11A and 11B are graphs showing the results of the experiment on Example 1 and Comparative example 1, respectively, in which FIG. 11A shows the results obtained using the immersion probe of the embodiment, and FIG. 11B shows the results obtained using a conventional immersion probe.

FIGS. 12A and 12B are graphs showing the results of the experiment on Example 2 and Comparative example 2, respectively, in which FIG. 12A shows the results obtained using the immersion probe of the embodiment, and FIG. 12B shows the results obtained using the conventional immersion probe.

### DESCRIPTION OF EMBODIMENT

In the following, an embodiment of the present invention will be described in detail with reference to the accompanying drawings.

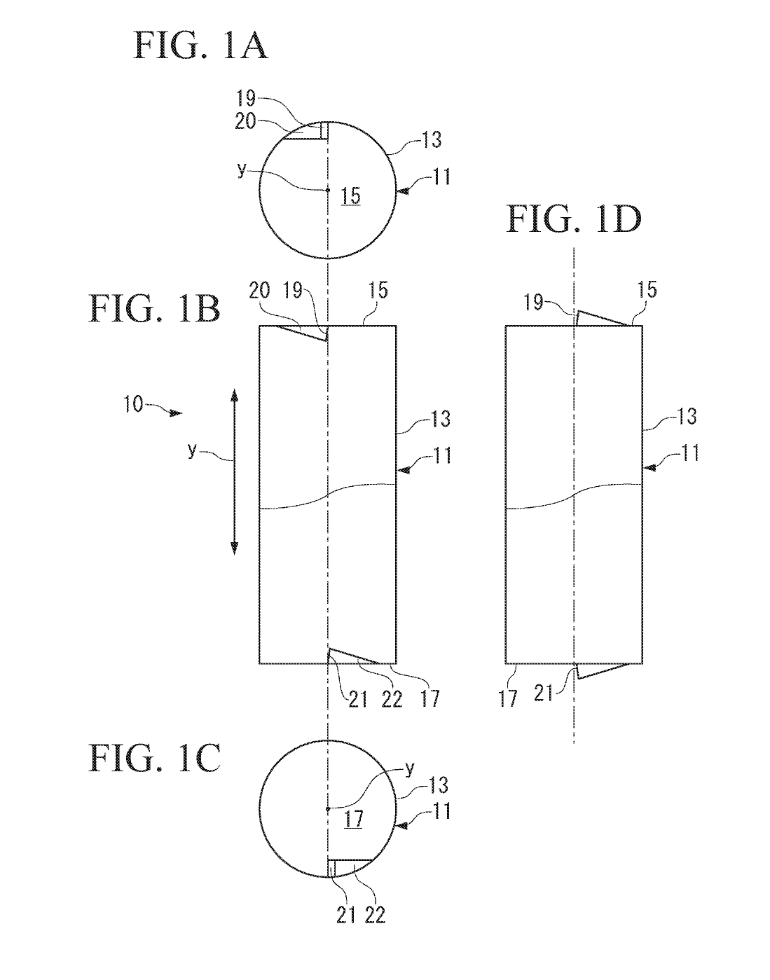

As shown in FIG. 1A to 1D, an ATR element 10 according to this embodiment includes an element main body 11, and an entrance surface 19 and an exit surface 21 which are provided integrally with the element main body 11. FIG. 1B combines the side on which the entrance surface 19 is provided and the side on which the exit surface 21 is provided.

### [Element Main Body 11]

The element main body 11 has a cylindrical shape as one form of axisymmetric shapes, and includes an outer circumferential surface 13, and one end face (first end face) 15 and the other end face (second end face) 17, which face in the direction of an axis of symmetry y. Here, the outer circumferential surface 13 is a surface which divides the element main body 11 from the surrounding space, and functions as a surface which reflects light traveling inside the element main body 11 on the inside of the ATR element 10. Thus, for matters relating to light reflection, the outer circumferential surface 13 may be referred to as the reflective surface 13.

A wide variety of materials which have a high refractive index and can cause total reflection when irradiated with light can be used as the element main body 11. Examples of such materials include fused quartz, sapphire, cubic zirconia (cubic-ZrO₂), zinc selenide (ZnSe), zinc sulfide (ZnS), and diamond. Of these materials, cubic zirconia or sapphire is preferable in terms of their high refractive index and inertness to an object being examined, when the cost is also taken into account.

### [Entrance Surface 19]

The entrance surface 19 is provided in the first end face 15 of the element main body 11, and when an object being measured is irradiated with infrared light as measuring light by an immersion probe including the ATR element 10, the measuring light enters the element main body 11 through this entrance surface 19.

The entrance surface 19 is formed so that its normal line N satisfies the following Conditions A and B relative to the reflective surface 13. These Conditions A and B are required for the measuring light having entered the ATR element 10 to follow a spiral passage route toward the second end face 17 by reflecting off the reflective surface 13 repeatedly multiple times. The normal line N of the entrance surface 19 substitutes the optical axis of the measuring light.

Actual measuring light DL is a flux of light which is introduced by an optical fiber, for example, and has a constant distribution of intensity, and this flux of light follows a spiral passage route along the reflective surface 13 of the ATR element 10 in the presence of evanescent light. In the following, a simple model will be used to describe the entry, reflection, etc. of the light for easy understanding.

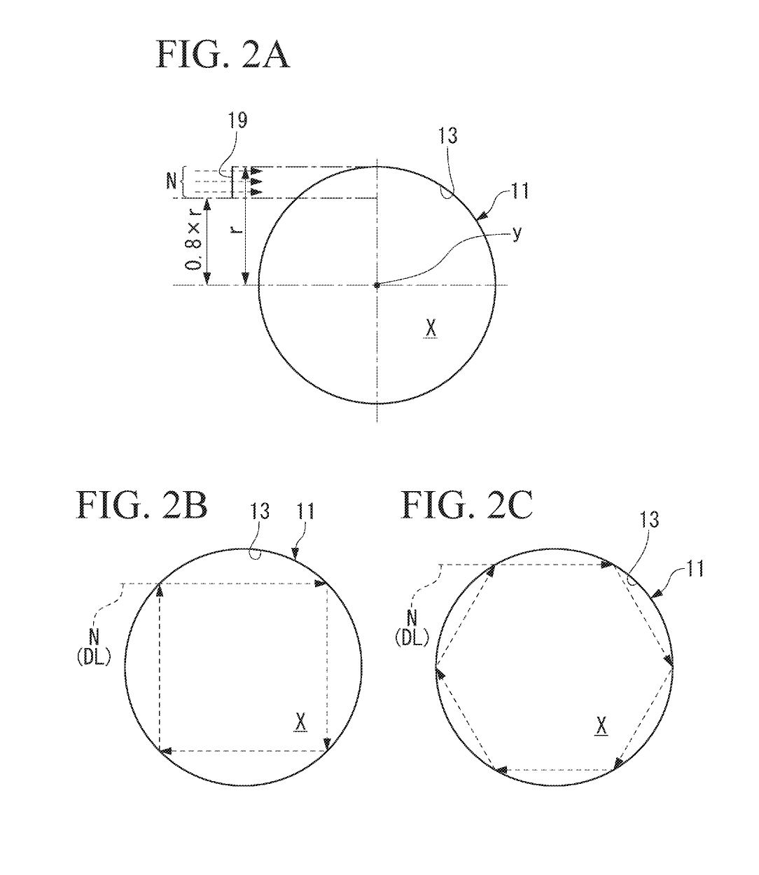

Condition A specifies that, as shown in FIG. 2A, the normal line N of the entrance surface 19 is located in a region of 80% or more but less than 100% of a radius r of a reference cross-section x perpendicular to the axis of symmetry y. This Condition A is required for a larger amount of measuring light DL to reflect off the reflective surface 13. That is, as can be seen from a comparison between FIG. 2B and FIG. 2C, the closer to the outer circumferential surface (reflective surface) 13 the measuring light DL enters, the larger the number of reflections of the measuring light DL by the reflective surface 13.

In accordance with Condition A, the entrance surface 19 of this embodiment is provided so as to be continuous with the outer circumferential surface 13 of the first end face 15. Thus providing the entrance surface 19 on the outermost circumference of the element main body 11 can increase the number of reflections by the reflective surface 13.

Next, Condition B specifies that an Angle θ_{NS} formed by the normal line N of the entrance surface 19 and the reference cross-section x is 45 degrees or less. This Condition B is required for the measuring light DL to follow a spiral passage route.

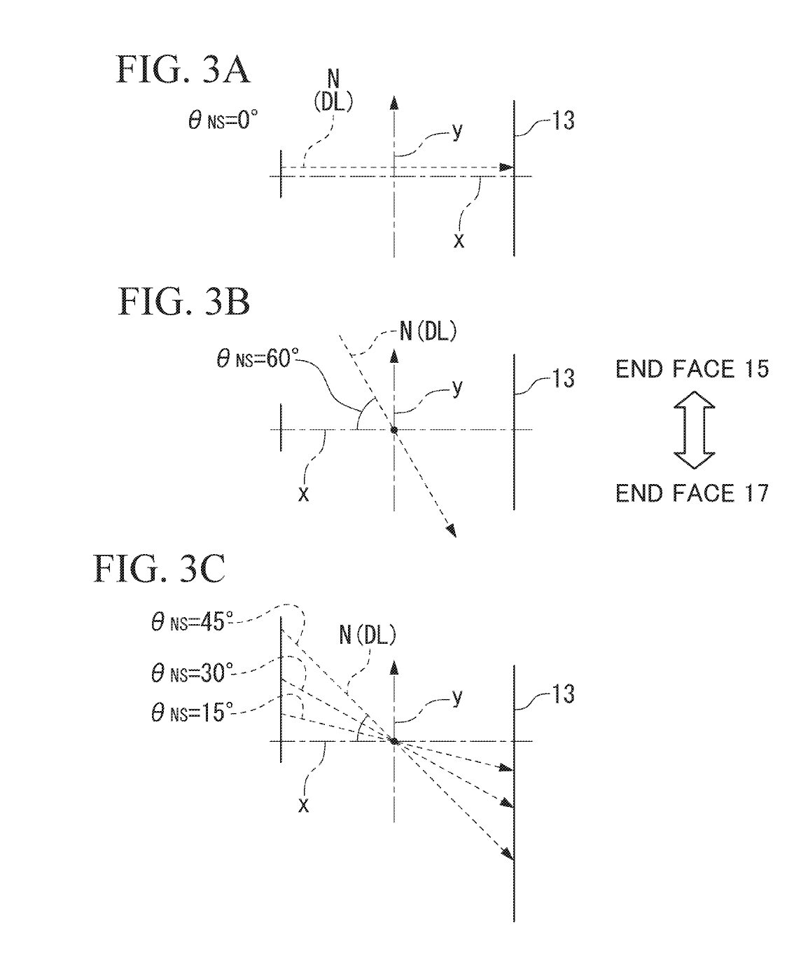

That is, as shown in FIG. 3A, if the normal line N is parallel to the reference cross-section x, i.e., if the angle θ_{NS} is 0 degrees, the measuring light DL turns into reflected light in the opposite direction at the reflective surface 13, so that theoretically the measuring light DL reflects repeatedly within the range of the same reference cross-section x.

In order for the measuring light DL to get out of the state shown in FIG. 3A and follow a spiral passage route, the angle θ_{Ns} should exceed 0 degrees. However, if this angle θ_{Ns} is too large as shown in FIG. 3B, the pitch of the spiral in the passage route becomes large, which is disadvantageous in increasing the number of reflections. It is therefore preferable that the angle θ_{NS} is 45 degrees or less as shown in FIG. 3C. The number of reflections increases with the decreasing angle θ_{NS}, so that the angle θ_{NS} is more preferably 30 degrees or less, and even more preferably 15 degrees or less.

Next, the entrance surface 19 is provided by forming a recess 20 in the first end face 15. Specifically, the recess 20 is formed by cutting a part of the originally flat first end face 15, and the wall surface formed as the recess 20 is formed is used as the entrance surface 19. This wall surface (entrance surface 19) has a planar shape. In view of securing the intensity of entering light, it is also acceptable to provide the recess 20 at a plurality of positions in the first end face 15, in the same rotation direction in a plan view, as long as interference of entering light can be reduced.

From the viewpoint of reducing the loss of the measuring light DL due to reflection or refraction at the joint surface, it is preferable that the element main body 11 including protrusions is integrally formed. In this respect, the above cutting process is preferable as it can easily form the integral element main body.

As shown in FIG. 1D, the entrance surface 19 can also be formed by protruding a part of the flat first end face 15. In this case, a conceivable method for producing the element main body 11 is to join together the protrusion and the major part of the element main body 11 which are separately produced. In this case, too, from the view point of reducing the loss of the measuring light DL due to reflection or refraction at the joint surface, it is preferable that the element main body 11 including the protrusion is integrally formed.

This integral structure can be realized by forming the element main body 11 to dimensions with the protrusions taken into account, and then cutting off the part other than the protrusions.

Thus, when forming one entrance surface 19, cutting the recess 20 (see FIG. 1B) is more preferable than cutting off the part other than the protrusion (see FIG. 1D) from the viewpoint of the man-hours and the material cost. However, when forming a plurality of entrance surfaces, both methods can be adopted from the viewpoint of the man-hours and the material cost. The same is true for the exit surface 21.

### [Exit Surface 21]

The exit surface 21 is provided so that the measuring light DL having entered through the entrance surface 19 can be taken out after it follows the spiral passage route by reflecting off the reflective surface 13 repeatedly multiple times. Therefore, the exit surface 21 is provided at a position corresponding to the passage route. As with the entrance surface 19, the exit surface 21 is provided in a recess 22.

The exit surface 21 of this embodiment is provided in the second end face 17, on the side opposite to the entrance surface 19 across the axis of symmetry y. Accordingly, as with the entrance surface 19, the exit surface 21 satisfies Condition A and Condition B described above. However, this is a preferred form, and the exit surface 21 basically functions as long as it is provided at a position corresponding to the spiral passage route.

This is because the measuring light DL is a flux of light having a constant distribution of intensity as described above, so that this flux of light exits unfailingly through the exit surface 21 by passing through the spiral route.

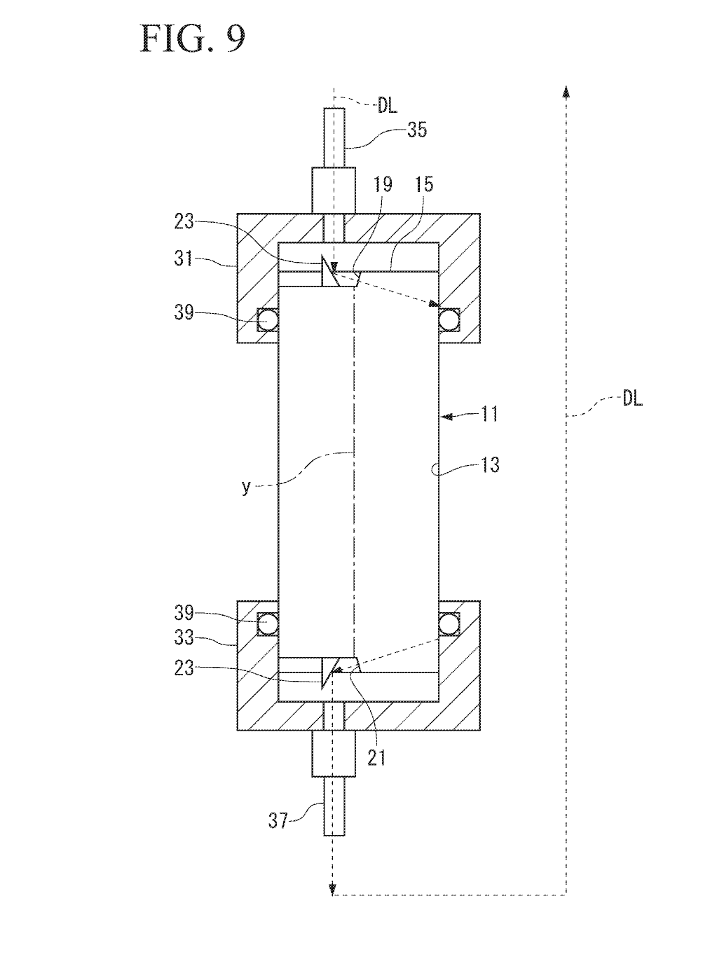

Therefore, for the entrance surface 19 in the first end face 15 shown in FIG. 1B, the exit surface 21 may be provided at the position in the second end face 17 shown in FIG. 1B, or for the entrance surface 19 in the first end face 15 shown in FIG. 1D, the exit surface 21 may be provided at the position in the second end face 17 shown in FIG. 1D. Moreover, for the entrance surface 19 in the first end face 15 shown in FIG. 9, the exit surface 21 may be provided at the position in the second end face 17 shown in FIG. 9.

Alternatively, the exit surface 21 can also be provided at a plurality of positions as with the entrance surface 19, and providing the exit surface 21 at a plurality of positions is also preferable from the viewpoint of securing the intensity of exiting light.

### [Form of Reflection]

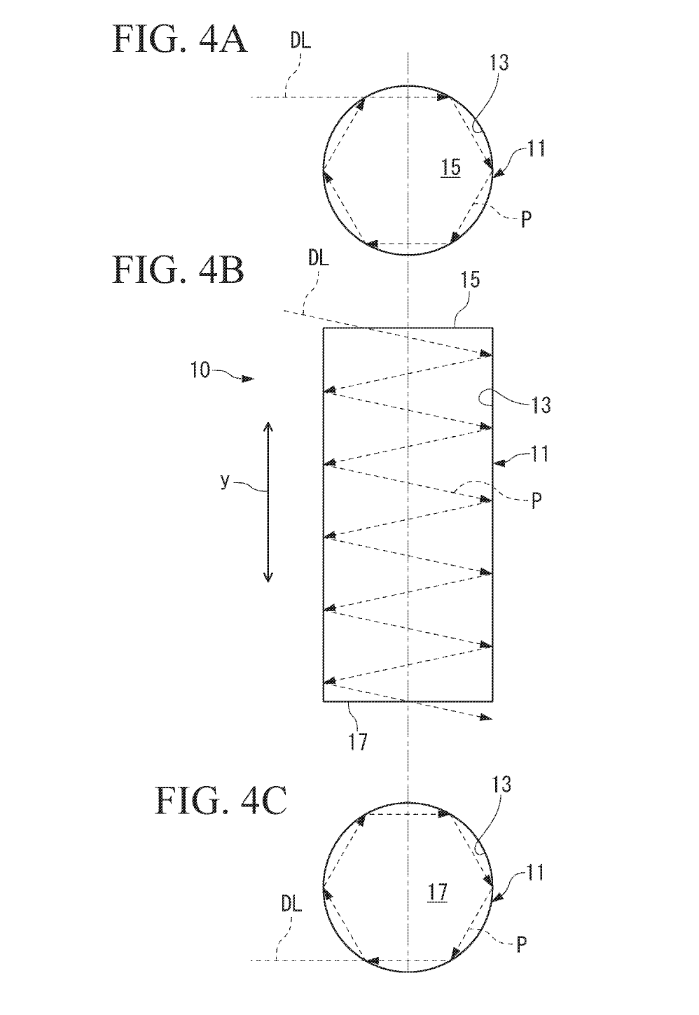

As shown in FIG. 4, in the ATR element 10 having been described above, when the measuring light DL enters inside the element main body 11 through the entrance surface 19, the measuring light DL follows a spiral passage route P, from the side of the first end face 15 toward the side of the second end face 17, while repeatedly totally reflecting off the reflective surface 13, and then exits through the exit surface 21 toward the outside. While the reflective surface 13 of the ATR element 10 is required to be at least partially in contact with the object being measured, from the viewpoint of effectively utilizing the entire spiral passage route P, it is preferable that the ATR element 10 is immersed in the object being measured so as to be in contact with the object being measured along the entire circumference of the reflective surface 13.

### [Modified Examples of Shape of Element Main Body]

As has been described above, according to the ATR element 10, the measuring light DL is continuously reflected off the reflective surface 13 which is continuous in the circumferential direction, and the reflection continues also in the axial direction, so that the number of reflections of the measuring light DL can be significantly increased.

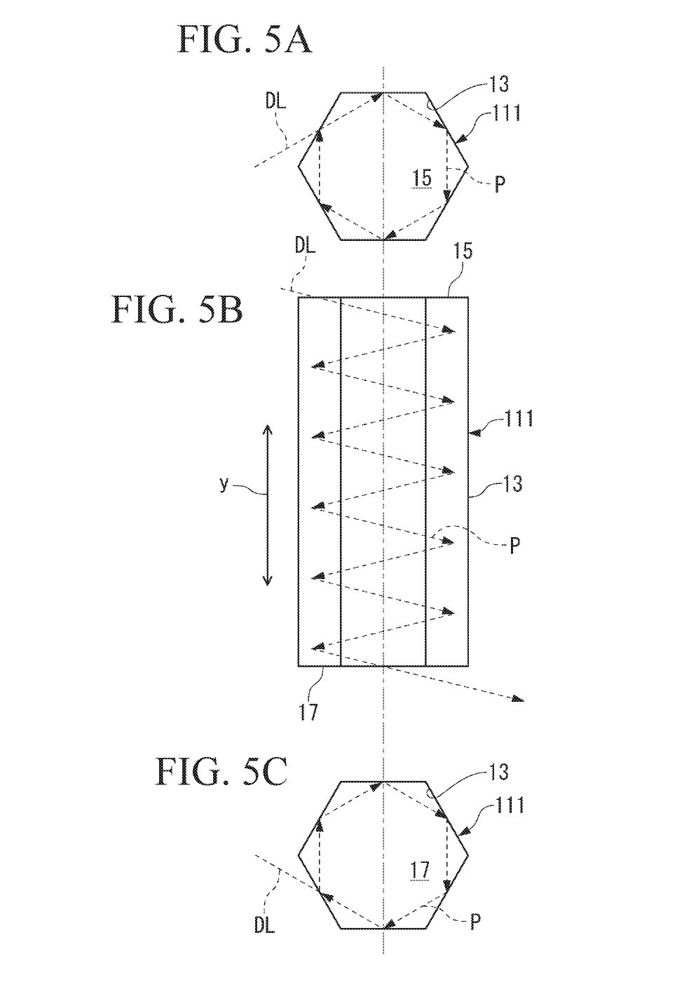

While the cylindrical element main body 11 is used for the ATR element 10, the form of the element main body of the present invention is not limited thereto. The lateral cross-section may have a polygonal shape, and, for example, an element main body 111 having a hexagonal lateral cross-section as shown in FIG. 5 can also be used.

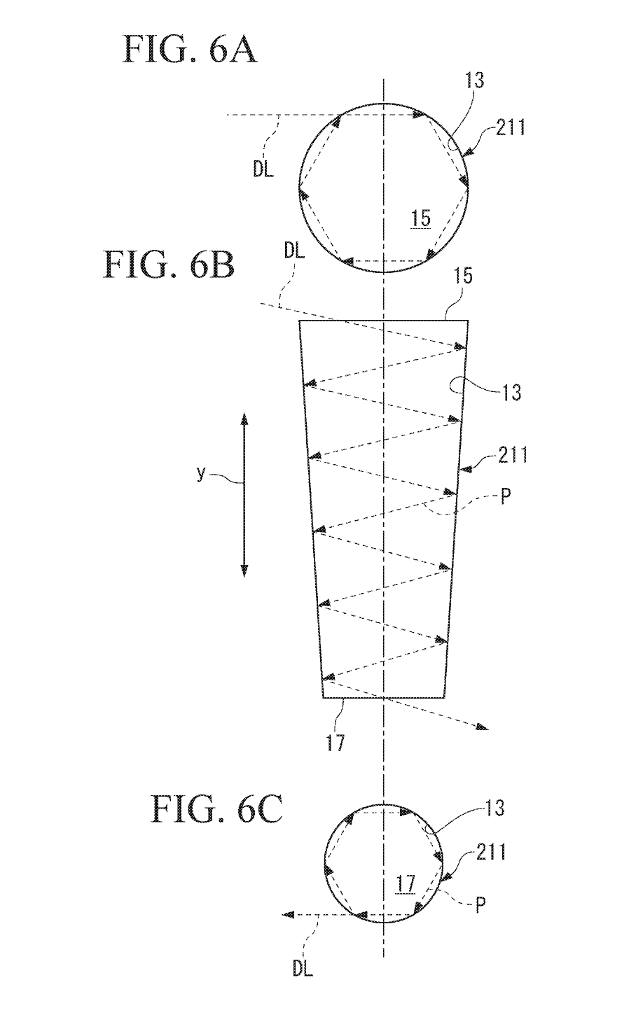

It is not necessary that the diameter of the element main body 11 having been described above is constant in the axial direction y, and, for example, an element main body 211 reduced in diameter from the first end face 15 toward the second end face 17 as shown in FIG. 6 can also be used. Moreover, it is also possible to continuously repeat a pattern in which the diameter is reduced and then increased again.

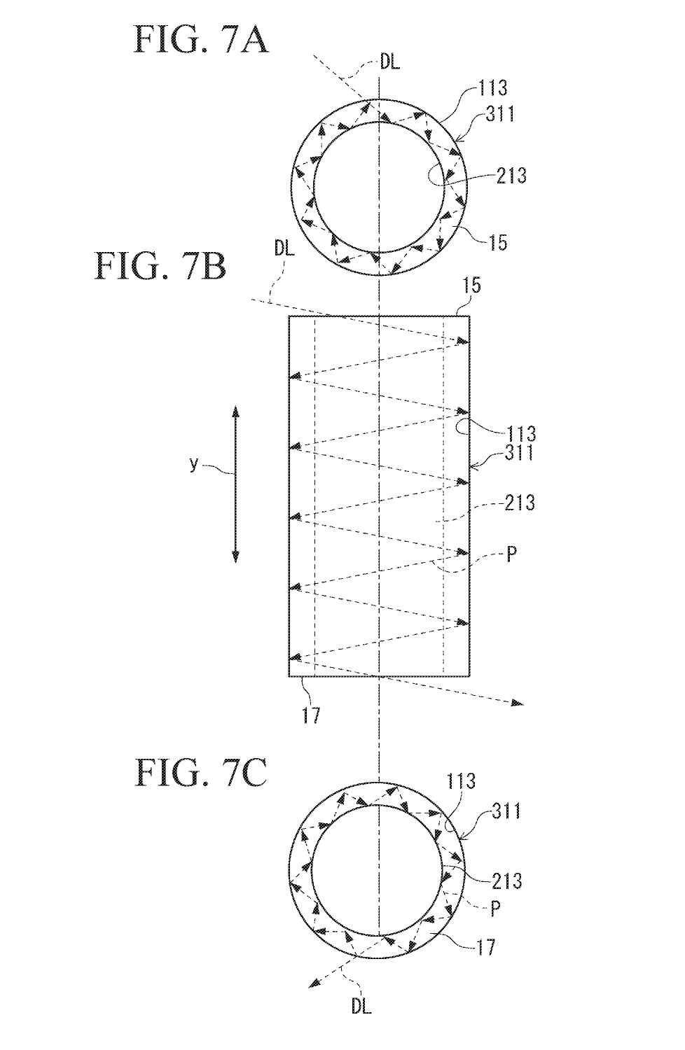

Furthermore, while the element main body 11 having been described above is formed by a solid cylinder, an element main body 311 can be formed by a hollow tube as shown in FIG. 7. As shown in FIG. 7, the tubular element main body 311 has not only an outer circumferential surface 113 but also an inner circumferential surface 213 to serve as a reflective surface, so that the number of reflections can be doubled compared with the element main body 11 having only the outer circumferential surface 13 to serve as the reflective surface.

It is preferable that the element main bodies 111, 211, 311 also satisfy Condition A and Condition B. In the case of the element main body 111 having a hexagonal lateral cross-section, the distance corresponding to the radius r of FIG. 2 can be the distance from the axis of symmetry y to the midpoint of each side as shown in FIG. 5.

In this case, each side of the hexagon can be regarded as the reflective surface of the element main body 111, and the measuring light DL follows a spiral passage route by being continuously reflected off the reflective surface.

For the element main bodies 111, 211, 311, too, evanescent light is present, under certain conditions, on the reflective surfaces (side surfaces of the element main bodies) of their respective forms.

### [Spectrophotometer]

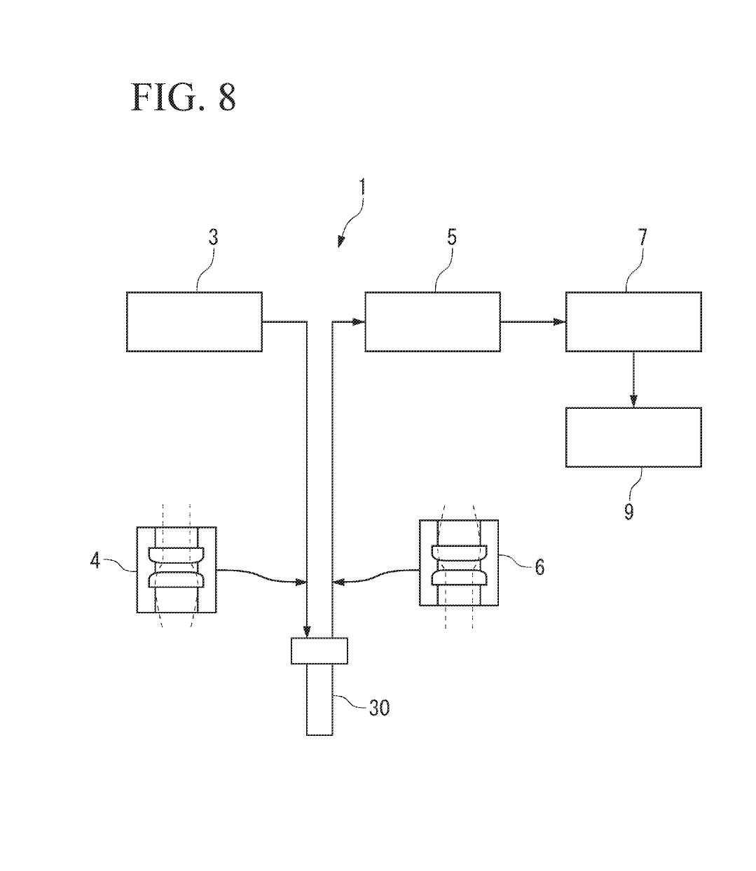

Next, a Fourier transform infrared spectroscopy spectrophotometer 1 using the ATR element 10 will be described with reference to FIG. 8 and FIG. 9.

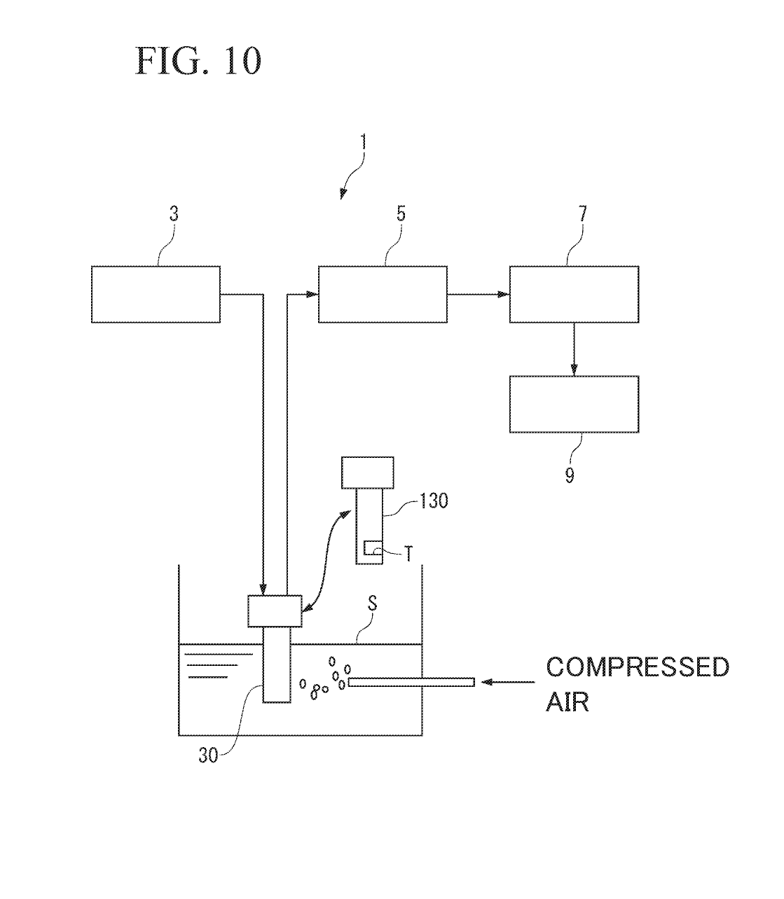

As shown in FIG. 8, the spectrophotometer 1 includes an ATR probe 30 having the ATR element 10, a light source 3, a spectrometer 5, a photodetector 7, and a data processing/display device 9. Optical fibers connect between the light source 3 and the ATR probe 30, the ATR probe 30 and the spectrometer 5, the spectrometer 5 and the photodetector 7, and the photodetector 7 and the data processing/display device 9. The actual lead-out positions of the optical fibers, which are simplified in FIG. 8, are as shown in FIG. 9. The same applies to FIG. 10.

The light source 3 generates the measuring light DL and emits the measuring light DL toward the ATR probe 30 (ATR element 10). The light source 3 is not particularly limited, and a halogen tungsten lamp and other publicly-known light sources can be used as the light source 3.

It is effective in reducing diffusion loss at the entrance surface 19 to pass the measuring light DL through a collimating lens 4 and thereby parallelize the measuring light DL before it enters the entrance surface 19 of the ATR element 10.

It is effective in reducing reflection loss at the entrance surface 19 to orient the measuring light DL to be perpendicular to the entrance surface 19 when it enters the entrance surface 19.

It is effective in reducing signal light loss to pass the measuring light DL, exiting through the exit surface 21, through a condensing lens 6 and thereby condense the measuring light DL before it enters an optical fiber 37.

The spectrometer 5 receives a beam emitted from the ATR probe 30 and divides it by wavelength. The spectrometer 5 is not particularly limited, and a diffraction grating spectrometer, an FTIR spectrometer, and other publicly-known spectrometers can be used as the spectrometer 5.

The photodetector 7 receives and detects the light dispersed by the spectrometer 5. The photodetector 7 is not particularly limited, and a photodiode, an avalanche photodiode, a photomultiplier tube, and other publicly-known photodetectors can be used as the photodetector 7.

The data processing/display device 9 generates spectrum information on the basis of infrared light received from the photodetector 7, and displays the generated spectrum information as image information. The data processing/display device 9 is not particularly limited, and a personal computer can be used for the data processing part, and a display device accompanying the personal computer can be used for the display part.

As shown in FIG. 9, the ATR probe 30 includes a first holder 31 on the side of the first end face 15 of the ATR element 10, and a second holder 33 on the side of the second end face 17 of the ATR element 10.

The first holder 31 holds the side of the first end face 15, and fixes an optical fiber 35 which guides from the light source 3 the measuring light DL radiated to the entrance surface 19. The second holder 33 holds the side of the second end face 17, and fixes the optical fiber 37 which receives the measuring light DL exiting through the exit surface 21 and guides the measuring light DL to the spectrometer 5.

O-rings 39 each are provided between the first holder 31 and the ATR element 10 and between the second holder 31 and the ATR element 10 to air-tightly seal the gaps from the outside and prevent the entry of the object being measured into the holding parts.

As shown in FIG. 9, the present invention embraces the use of a prism 23 to cause the measuring light DL to diffract and enter the entrance surface 19, as well as the use of the prism 23 to cause the measuring light DL exiting through the exit surface 21 to diffract. The use of the prism 23 allows the optical fiber 35 to be routed in parallel to the axis of symmetry y. The same is true for the exit surface 21.

As shown in FIG. 9, in a state where the ATR probe 30 is immersed in a liquid object being measured L, in the spectrophotometer 1 the measuring light DL from the light source 3 enters the entrance surface 19 of the ATR element 10 through the optical fiber 35, and the measuring light DL exiting through the exit surface 21 is received by the optical fiber 37 and guided to the spectrometer 5. Subsequently, the spectrum information on the object being measured is displayed through the photodetector 7 and the data processing/display device 9, so that the state of reactions of the object being measured can be grasped.

In this process, since the measuring light DL undergoes a large number of reflections off the reflective surface 13 inside the ATR element 10, the wavelength specific to an object being measured S is absorbed to a significant extent. In addition, since the ATR probe 30 measures the object being measured S in contact with the outer circumferential surface 13 of the ATR element 10, there is little possibility of errors caused by the presence of air bubbles. Thus, the spectrophotometer 1 using the ATR element 10 is capable of high-precision measurement.

While the object being measured S of the spectrophotometer 1 is arbitrary, if a reaction liquid in the manufacturing process of a synthetic resin containing a reactive group (e.g., —NCO, —OH, —COOH) is used as the object being measured 5, the progress of reactions can be precisely grasped.

Thus, it is possible to favorably manufacture a desired final product by monitoring the process of synthetic reactions of the product, as long as the product, whether it is organic or inorganic, undergoes synthetic reactions in the manufacturing process, such as synthetic resin products, liquid crystal products, or pigment products. The present invention can be used in a wide range of applications including, not only manufacturing-related process management in the fields of chemical goods, medical goods, industrial powder goods, foods, etc., but also, by industry, chemistry; various resins and plastics represented by polyurethane, polyester, epoxy, and reactive hot melt; test, analysis, and measurement; medical goods and biology; education/research institutions, etc.

### EXAMPLES

In the following, the present invention will be described in more detail using examples.

### Example 1

An experiment for confirming the effects of the ATR element 10 according to the embodiment, particularly, an experiment of intentionally generating air bubbles around the ATR element 10, was performed.

The production conditions of the ATR element used for the experiment were as follows (see FIGS. 1A, 1B, 1C; the numbers of the recesses 20, 22 were both one).

Material: Sapphire

Shape: Cylinder (diameter: 20 mm; effective length of immersion in the object being measured S: 60 mm)

Angle θ_{NS}: 2.5 degrees (estimated spiral pitch: 1.75 mm)

Radial position of entry of measuring light: 0.915r (estimated reflection route: dodecagonal)

Estimated number of reflections: 411

The conditions for the configuration of the spectrophotometer were as follows.

Light source: Halogen tungsten lamp “HL-2000” by Ocean Optics

Spectrometer: Diffraction grating spectrometer “MicroHR”, 600 lines/mm, by HORIBA

Photodetector: APD detector “SPD_A_M1” by AUREA

In the experiment, air bubbles were blowed after a lapse of a predetermined time from the start of measurement (see FIG. 10). The object being measured S was toluene, and the spectral wavelength of the spectrometer 5 was 1400 nm.

### Comparative Example 1

The experiment was also performed on a transmission probe (“IN237P10” by Hellma) 130, which has a cavity T filled with the object being measured 5, in the same manner as with Example 1.

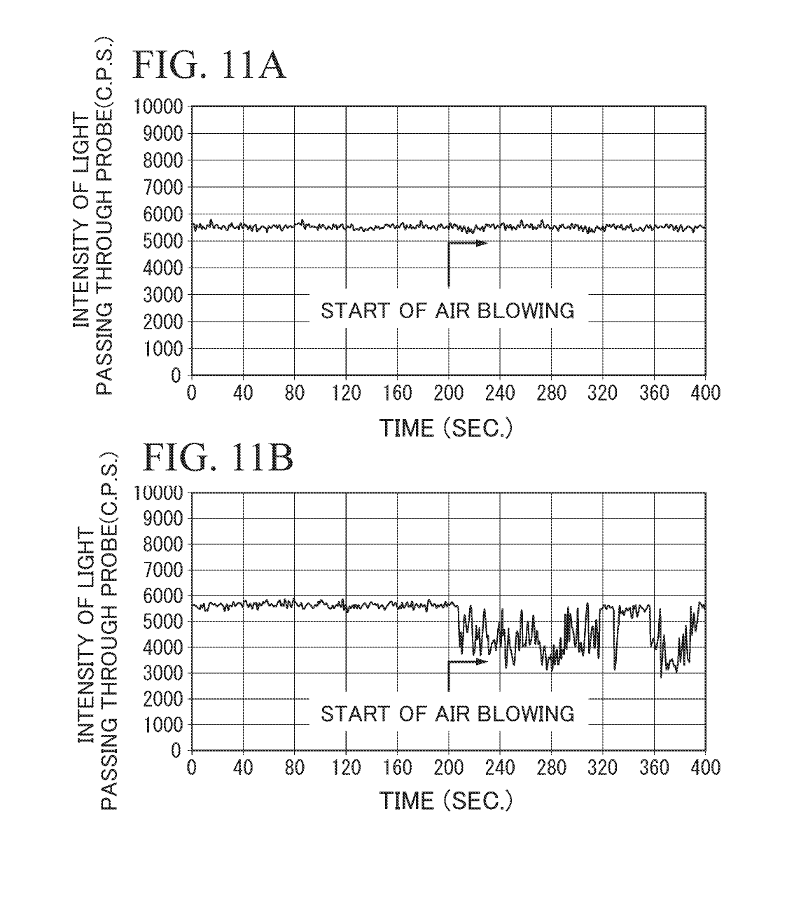

FIG. 11 shows the results. In Comparative example 1, the measurement results varied significantly after the blowing of air bubbles was started. By contrast, in Example 1 according to the embodiment, no difference was found between the measurement results before and after the blowing of air bubbles. This shows that, in this embodiment, the presence or absence of air bubbles has no influence on the measurement results.

### Example 2

The ATR element 10 of Example 1 was immersed in toluene which was the object being measured 5, and the absorbance spectrum was measured (see FIG. 10).

As for the measurement conditions, the spectrophotometer of Example 1 was used, and the experiment was performed over the range of the selection wavelength of the spectrometer of 1100 nm to 1700 nm in increments of 1 nm.

### Comparative Example 2

The absorbance spectrum was measured in the same manner as with Example 2, except that the ATR element “661. 820-NIR” by Hellma was used.

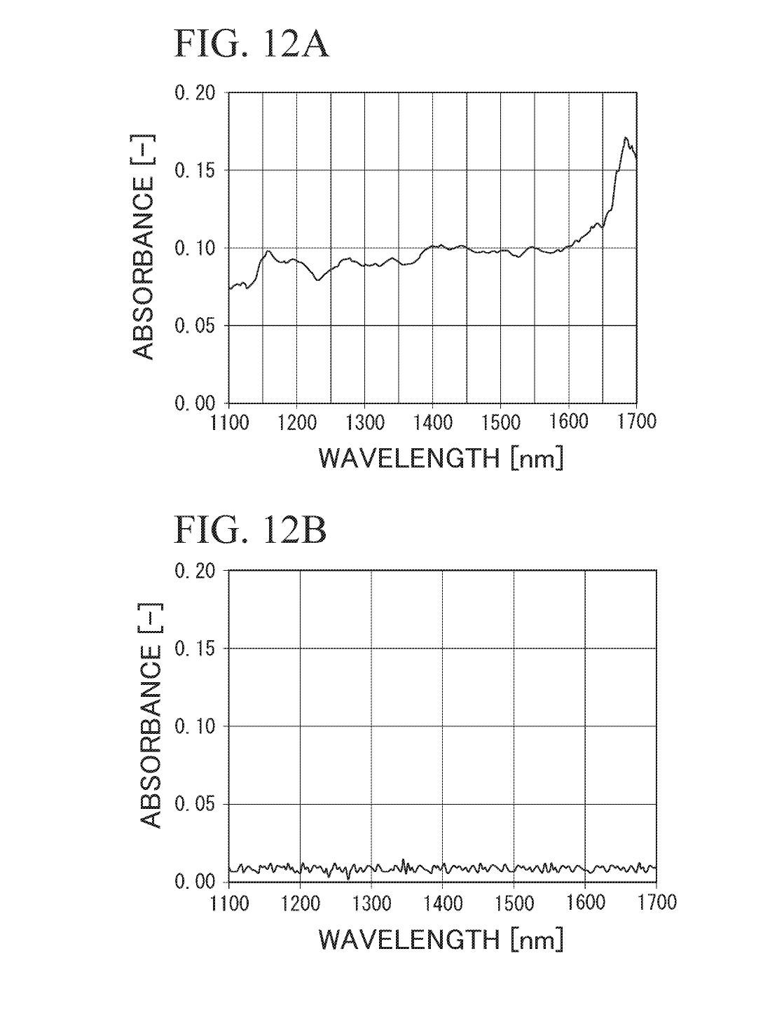

FIG. 12 shows the measurement results.

In the absorbance spectrum of Example 2, there are peaks at about 1160 nm and about 1680 nm which are presumed to be derived from a methyl group and a benzene ring, respectively. Since the reproducibility was high when this spectrum was repeatedly measured (not shown), it is expected that in future the presence of toluene around the ATR element 10 according to the embodiment can be determined from these peaks by further examining the spectra of various substances having a benzene ring and a methyl group using the spectrophotometer of the present invention.

By contrast, in the absorbance spectrum of Comparative example 2, no peaks are found, and evidence for the presence of toluene around the ATR element “661. 820-NIR” could not be obtained, either.

While the preferred embodiment of the present invention has been described above, the configurations presented in the above embodiment can be selectively adopted or appropriately modified into other configurations within the scope of the present invention.

For example, in the element main body 11, the first end face 15 and the second end face 17 are perpendicular to the axis of symmetry y, but the present invention is not limited to this example, and these end faces may be inclined relative to the axis of symmetry y. Moreover, while the first end face 15 and the second end face 17 are parallel to each other in the element main body 11, the present invention is not limited to this example, and these end faces may be inclined in opposite directions.

Thus, according to the present invention, it is possible to favorably manufacture a desired final product by monitoring the process of synthetic reactions of the product, as long as the product, whether it is organic or inorganic, undergoes synthetic reactions in the manufacturing process, such as synthetic resin products, liquid crystal products, or pigment products. The present invention can be used in a wide range of applications including, not only manufacturing-related process management in the fields of chemical goods, medical goods, industrial powder goods, foods, etc., but also, by industry, chemistry; various resins and plastics represented by polyurethane, polyester, epoxy, and reactive hot melt; test, analysis, and measurement; medical goods and biology; education/research institutions, etc.

### REFERENCE SIGNS LIST

1 Spectrophotometer
3 Light source
4 Collimating lens
5 Spectrometer (photometer main body)
6 Condensing lens
7 Photodetector (photometer main body)
9 Data processing/display device
10 ATR element
11 Element main body
13 Outer circumferential surface, reflective surface
15 First end face
17 Second end face
19 Entrance surface
21 Exit surface
20, 22 Recess
23 Prism
30 ATR probe
31 First holder
33 Second holder
35, 37 Optical fiber
39 O-ring
111, 211, 311 Element main body
113 Outer circumferential surface, reflective surface
213 Inner circumferential surface
DL Measuring light
N Normal line
T Cavity
P Passage route

1. An ATR element comprising:
an element main body formed by an axisymmetric solid and having a reflective surface continuous in a circumferential direction;
an entrance part through which measuring light enters the element main body; and
an exit part through which the measuring light entering through the entrance part and reflected off the reflective surface of the element main body exits to the outside, wherein
the element main body has a cylindrical form,
the measuring light is light in a near-infrared region having a wavelength of 1000 to 2000 nm,
the measuring light having entered through the entrance part follows a spiral passage route while repeatedly reflecting off the reflective surface before exiting through the exit part toward the outside,
in a reference cross-section (x) perpendicular to the axis of symmetry of the element main body, the entrance part is located at a distance of 80% or more but less than 100% of the distance from the axis of symmetry to the outer circumference of the reference cross-section, and
an angle formed by a normal line of the entrance part and the reference cross-section is more than 0 degrees but not more than 45 degrees.

2.-3. (canceled)

4. The ATR element according to claim 1, wherein
the element main body has a first end face facing in the axial direction and a second end face facing the first end face,
the entrance part is provided by forming a recess in the first end face, and
the exit part is provided by forming a recess in the second end face.

5. The ATR element according to claim 4, wherein
the entrance part is formed so as to be continuous with the outer circumference of the first end face, and
the exit part is formed so as to be continuous with the outer circumference of the second end face.

6. An immersion probe comprising:
the ATR element according to claim 1;
first light-guiding means which guides the measuring light emitted from a light source to the entrance part; and
second light-guiding means which guides the measuring light exiting through the exit part to a predetermined position.

7. A spectrophotometer comprising:
the immersion probe according to claim 6;
a light source which emits the measuring light; and
a photometer main body which disperses and detects the measuring light having passed through the immersion probe.

8.-9. (canceled)

10. The ATR element according to claim 1, wherein
the element main body comprises sapphire.

11. An ATR element comprising:
an element main body formed by an axisymmetric solid and having a reflective surface continuous in a circumferential direction;
an entrance part through which measuring light enters the element main body; and
an exit part through which the measuring light entering through the entrance part and reflected off the reflective surface of the element main body exits to the outside, wherein
the element main body has a cylindrical form,
the measuring light is light in a near-infrared region having a wavelength of 1000 to 2000 nm,
the measuring light having entered through the entrance part follows a spiral passage route while repeatedly reflecting off the reflective surface before exiting through the exit part toward the outside.

12. The ATR element according to claim 1, wherein
the ATR element is used for an immersion probe which measures changes in concentration of a reactive group.

13. The ATR element according to claim 11, wherein
the ATR element is used for an immersion probe which measures changes in concentration of a reactive group.

14. An immersion probe comprising:
the ATR element according to claim 11;
first light-guiding means which guides the measuring light emitted from a light source to the entrance part; and
second light-guiding means which guides the measuring light exiting through the exit part to a predetermined position.

15. An immersion probe comprising:
an ATR element having an element main body which is formed by an axisymmetric solid and has a reflective surface continuous in a circumferential direction; an entrance part through which measuring light enters the element main body; and an exit part through which the measuring light entering through the entrance part and reflected off the reflective surface of the element main body exits to the outside;
a first optical fiber which guides the measuring light emitted from a light source to the entrance part; and
a second optical fiber which guides the measuring light exiting through the exit part to a predetermined position; and wherein
the measuring light is light in a near-infrared region having a wavelength of 1000 to 2000 nm,
the measuring light having entered through the entrance part follows a spiral passage route while repeatedly reflecting off the reflective surface before exiting through the exit part toward the outside.

16. The immersion probe according to claim 15, wherein the element main body has a cylindrical form.

17. A spectrophotometer comprising:
the immersion probe according to claim 14;
a light source which emits the measuring light; and
a photometer main body which disperses and detects the measuring light having passed through the immersion probe.

18. A spectrophotometer comprising:
the immersion probe according to claim 15;
a light source which emits the measuring light; and
a photometer main body which disperses and detects the measuring light having passed through the immersion probe.
